(19) United States
(12) Patent Application Publication
(10) Pub. No.: US 2003/0048996 A1
(43) Pub. Date: Mar. 13, 2003

(54) Removable fiber strain relief and locking apparatus

(76) Inventors: Thomas F. Lowe, Nepean (CA); Jamie Wildgen, Kanata (CA); Michael Moy, Stittsville (CA)

Correspondence Address: WOOD, HERRON & EVANS, L.L.P., 2700 Carew Tower, 441 Vine St., Cincinnati, OH, 45202, US

(21) Appl. No.: 10/236,805

(22) Filed: Sep. 6, 2002

Related U.S. Application Data
(60) Provisional application No. 60/317,130, filed on Sep. 6, 2001.

(51) Int. Cl. G02B 6/36

(52) U.S. Cl. 385/81; 385/78

(57) ABSTRACT

A method and apparatus for securing an optical fiber to a structure and an appropriate strain relief boot to the optical fiber as well as to the structure is disclosed. A channel is formed proximate to an opening in a wall surface of the structure. The fiber is inserted into a passage in a compressible ferrule sized to accommodate the fiber and having a lip around its body and a strain relief boot is slid over one longitudinal end of the fiber to cover the lip. The ferrule and boot are inserted into a channel sized to accommodate the ferrule in a friction fit. The ferrule is cylindrical in shape and has one or more passages through it, aligned along the longitudinal axis of the cylinder. A slot extends the length of the ferrule between its outer surface and a passage proximate thereto. Slots may interconnect passages. The diameter along which the slots extend terminate in notches which narrow the ferrule width along this direction. A key is formed on the outer surface of the ferrule to mate with a keyway in the channel and secure the ferrule to the channel. The channel is U-shaped and has a width greater than the cylinder's narrow dimension but less than its wide dimension. If the ferrule is inserted so that its narrow dimension extends between the ends of the channel, no compressive force is applied and the fiber is free to move relative to the ferrule. If the ferrule is inserted in a direction normal to this, the channel applies compressive force, shrinking the passage diameter and applying a uniform compressive force to the fiber, securing it to the ferrule. At the same time, the lip on the ferrule cooperates with the channel to clamp the boot to the fiber. The ferrule may be enclosed between the channel and a retaining member to ensure uniform clamping pressure on the boot.

### CROSS-REFERENCE TO PRIOR APPLICATIONS

This application claims priority from U.S. Provisional Application No. 60/317,130 of the same title filed Sep. 6, 2001 by Trillium Photonics Inc. and naming Lowe et al. as inventors.

### FIELD OF THE INVENTION

This invention relates to optical communications systems and in particular to an improved strain relief and locking apparatus for attaching optical fibers to a structure.

### BACKGROUND OF THE INVENTION

Optical fibers are used as a medium for light transmission in optical communications. The optical characteristics of these fibers are dramatically affected by mechanical stresses imparted by bending, pulling and/or twisting the fibers. Such stresses can be introduced when fibers are not properly retained and strain relieved when entering and exiting a structure, such as a wall of an optical component, module or enclosure, or through a faceplate.

It is known to apply adhesives over the outer fiber jacket and strain relief boot in order to bond them directly to the wall of the structure. However, the constrained space in which the fiber is situated makes it difficult to properly apply the adhesive. Moreover, in the application process, the fiber is frequently subjected to increased mechanical stresses, such as bending, twisting and stretching of the fiber. Such stresses, introduced during the application and curing of the adhesive, will remain and affect both the short term and long term optical performance of the fiber.

Additionally, if the adhesive is improperly applied or not permitted to fully cure, the fiber will be inadequately retained. The effectiveness of the adhesive used is reduced by changes in both temperature and humidity. Thus, the use of adhesives may not be conducive to some applications.

Furthermore, once the adhesive is applied and cured, it is very difficult to remove the fiber and its strain relief boot from the structure. It is common in both the development and manufacturing process and during operation, to remove and re-attach the fibers from time to time. If adhesive has been applied, the fiber must be cut beyond the applied adhesive, re-spliced and then attached to the structure anew. Beyond the inconvenience and effort entailed in removing the adhesive and the discarded portions of the fiber from the structure, it is not trivial to re-splice the fiber, and re-attaching the fiber in this manner reduces the length of the fiber available. This process in turn may introduce additional mechanical stress in the fiber.

Other approaches have attempted to provide a removable connection mechanism. These approaches typically make use of a threaded connection mechanism which can be tightened to apply pressure on the fiber and thus lock it in place and loosened in order to permit repositioning of the fiber as required. However, such approaches suffer from a number of disadvantages.

First, as the connection mechanism is being tightened about the fiber, it begins to come into frictional engagement with the fiber. After this point, as the connection mechanism continues to be turned to further tighten the connection, the fiber undergoes torsional stresses in the direction of rotation of the connection mechanism. Torsional stresses are generally to be avoided in optical communications systems because they increase the likelihood of crack formation and introduce unacceptable degradation of the optical performance of the fiber.

Second, when the connection mechanism is subsequently loosened, by turning the connection mechanism in the opposite direction, the fiber undergoes torsional stresses in the opposite direction. The stresses introduced by the tightening and the loosening of the connection mechanism tend to accumulate rather than cancel out.

Third, the connection mechanisms used in such applications tend to provide contact with the fiber only at a localized region along the longitudinal length of the connection mechanism. As pressure is applied at this localized region, the pressure will cause localized deformation of the fiber and consequent performance degradation. Moreover, if there is any bending or twisting of the cable, the fiber may break at the pressure point.

Thus, it is difficult, if not impossible, to adjust the connection mechanism while the fiber is operational, in order to ensure that the optical performance is not degraded by the use of the connection mechanism.

In U.S. Pat. No. 6,142,679 entitled “Connection mechanism for Optical Waveguides” issued Nov. 7, 2000 to Bredthauer et al., a removable waveguide connection mechanism is disclosed comprising a complicated structure designed to avoid the introduction of torsional stresses. However, the connection mechanism contains a large number of interlocking parts in order to effect this result. The connection mechanism is accordingly relatively long, which limits its applicability in small footprint applications, and introduces the possibility of fiber breakage where the fiber exits the connection mechanism at either end.

Furthermore, while technically removable, the Bredthauer connection mechanism requires that the outer jacket and the intermediate insulation be removed from the fiber. The removal of the jacket is irreversible, and does not permit the fiber to be repositioned longitudinally.

Additionally, the process of removing the outer jacket of the fiber may introduce stress or even breakage in the fiber.

In U.S. Pat. No. 6,072,931 entitled “Fiber Amplifier Packaging Apparatus” and issued on Jun. 6, 2000 to Yoon et al., there is disclosed a locking apparatus for attaching a fiber to a structure. The structure has a rectangular slot through which the apparatus passes. The external surface of a longitudinal portion of the apparatus is flattened in order to engage the slot and prevent twisting of the fiber. The flat surface of the apparatus is bounded by circular stoppers of a diameter greater than the width of the slot to prevent the fiber from extending too far in either longitudinal direction beyond the structure.

While the locking apparatus itself is removable from the structure, a portion of the outer jacket of the fiber itself must be removed in order to fit the apparatus onto the fiber, with sufficient friction to grip the fiber.

In addition to the problems discussed above inherent in the removal of the jacket, when the apparatus is fitted onto the optical fiber, the fiber may be unduly stressed or even break. Of greater concern, positioning the apparatus in a friction fit about the fiber may introduce unpredictable and uneven stresses on the fiber, especially with the jacket removed, that would adversely impact the optical performance of the fiber.

In U.S. Pat. No. 5,742,719 entitled “Fastening Device for Light Waveguides” issued Apr. 21, 1998 to Birnbaum, there is disclosed a cuboid fastening device capable of fastening and providing strain relief of two fibers. The fibers are introduced into one of two longitudinal bores extending along the length of a base member proximate to the side walls of the base member. A transverse slot is provided for at least a portion of the length of the bore extending to the side wall. A clamp member engages a clamp rail at the side wall to form a frictional lock on the fiber within the bore. A retainer plate is inserted into a retainer slot extending parallel to one of the end faces. Slots in the plate correspond to the fibers within the bores and have a diameter to tightly engage the fibers. The plate is keyed to engage the base member, but, with effort, may be subsequently released.

However, the Birnbaum device requires, in addition to the base member, two clamps and a retaining plate, all of which are small loose components and prone to be dropped or misplaced. Further, in order to fix the fastening device to a structure, the fastening device must be inserted into a socket plug housing or a pin connection mechanism housing. Moreover, the interaction of the clamp member and the clamp rail, as well as the engagement of the slots in the retainer plate with the fiber apply pressure on the fiber at localized points and not along the length of the bore. Still further, the jacket and the first covering must be removed from the fiber ends in order to engage centering sleeves or projections that extend from the distal end surface and provide an extension for each of the bores.

In U.S. Pat. No. 5,146,532 entitled “Optical Fiber Retention Device” issued Sep. 8, 1992 to Hodge, there is disclosed a stackable resilient strip member having one or more generally U-shaped channels disposed transversely along one surface of the strip between a pair of keyways. These channels support individual optical fibers in a common plane. The opposing surface of the strip is generally planar, but has resilient keys adapted to engage the keyways of a second identical strip member. The planar surface provides some frictional engagement of the optical fibers.

While the strip members are nominally removable, the wedge-shaped keys that connect the strip members do not admit of easy separation. Moreover, the pressure applied by the planar surface of the strip member will not be uniform across all of the connection mechanisms. Further, the pressure is applied only to one side of the connection mechanism, by the planar surface, thus introducing a distortion across the cross-section of the fiber. Finally, a delicate trade-off must be made between the depth of the U-shaped channels and the resiliency of the underlying material in order to provide sufficient pressure to fix the position of the fiber relative to the strip member. Therefore, this approach is not easily adaptable to fibers of differing dimension.

The introduction of a strain relief boot at the point of exit of a fiber from an optical connection mechanism is also well known. Typically, the strain relief boot is elongated and exteriorly tapered and slips over the rear end portion of the connection mechanism. The prior art in respect of strain relief boots is canvassed in U.S. Pat. No. 5,915,056 entitled “Optical Fiber Strain Relief Device” issued Jun. 22, 1999 to Bradley et al. Typical strain relief boot installations merely provide strain relief in the lateral direction only.

There are a number of methods of affixing the strain relief boot to the connection mechanism. For instance, the boot may be cemented to the cap. The former approach requires the handling of adhesives with the problems hereinbefore described.

Alternatively, the boot may be tapered at the end proximal to the connection mechanism and slid under the connection mechanism. The proximal end of the connection mechanism terminates in a series of lips or ridges which engage shoulders within the connection mechanism to fix the boot to the connection mechanism. This approach is relatively permanent as the connection mechanism is not easily removed. Moreover, it requires a degree of customization between the strain relief boot and the connection mechanism to be used, in order that the boot may slide under the connection mechanism already in place.

### SUMMARY OF THE INVENTION

Accordingly, it is desirable to provide an improved removable fiber strain relief and locking apparatus.

It is also desirable to provide a locking apparatus with a minimum of separate parts.

It is further desirable to provide such an apparatus that does not require removal of any part of the first covering of the optical fiber.

It is still further desirable to provide a locking apparatus that applies pressure uniformly about both the cross-sectional and longitudinal extent of the fiber so as not to introduce any degradation of the optical performance of the fiber.

It is also desirable to permit the adjustment of the fiber relative to the structure while the fiber is operational, in order to permit the fiber to be adjusted to suit a designed length without degradation to the fiber.

Moreover, it is desirable to provide a mechanism for easily and removably affixing a strain relief boot to the structure.

The present invention accomplishes these aims by providing a method and apparatus for securing an optical fiber to a structure and an appropriate strain relief boot to the optical fiber as well as to the structure. A channel is formed proximate to an opening in a wall surface of the structure. The fiber is inserted into a passage in a compressible ferrule sized to accommodate the fiber and having a lip around its body and a strain relief boot is slid over one longitudinal end of the fiber to cover the lip. The ferrule and boot are inserted into a channel sized to accommodate the ferrule in a friction fit. The ferrule is cylindrical in shape and has one or more passages through it, aligned along the longitudinal axis of the cylinder. A slot extends the length of the ferrule between its outer surface and a passage proximate thereto. Slots may interconnect passages. The diameter along which the slots extend terminate in notches which narrow the ferrule width along this direction. A key is formed on the outer surface of the ferrule to mate with a keyway in the channel and secure the ferrule to the channel. The channel is U-shaped and has a width greater than the cylinder's narrow dimension but less than its wide dimension. If the ferrule is inserted so that its narrow dimension extends between the ends of the channel, no compressive force is applied and the fiber is free to move relative to the ferrule. If the ferrule is inserted in a direction normal to this, the channel applies compressive force, shrinking the passage diameter and applying a uniform compressive force to the fiber, securing it to the ferrule. At the same time, the lip on the ferrule cooperates with the channel to clamp the boot to the fiber. The ferrule may be enclosed between the channel and a retaining member to ensure uniform clamping pressure on the boot.

According to a broad aspect of the present invention, there is disclosed a ferrule comprising: a compressible body; and at least one passage through the body sized to accommodate a fiber; whereby when a fiber is placed inside the at least one passage and pressure is exerted on the body, the body is compressed, causing the diameter of the at least one passage to decrease uniformly along its length and consequently friction to be uniformly applied to the fiber.

According to a second broad aspect of the present invention, there is disclosed a ferrule comprising: a body; and a lip integrally formed around the body and adapted to cooperate with a channel in a friction fit; whereby when a boot is slid longitudinally over one end of the apparatus to cover the lip and the apparatus is inserted into a channel, the channel and the lip secure the boot to the apparatus.

According to a third broad aspect of the present invention, there is disclosed a channel sized to accommodate a compressible body in a friction fit, whereby when a compressible body having at least one passage sized to accommodate a fiber and containing a fiber is inserted into the channel, the channel compresses the body uniformly along the length of the body and causes friction to be uniformly applied by the body to the fiber.

According to a fourth broad aspect of the present invention, there is disclosed a channel, adapted to accommodate a body having a lip therearound in a friction fit, whereby when a boot is slid longitudinally over one end of the body to cover the lip and inserted into the channel, the channel and the lip secure the boot to the body.

According to a fifth broad aspect of the present invention, there is disclosed a retaining member adapted to accommodate a body having a lip therearound, whereby when a boot is slid longitudinally over one end of the body to cover the lip and the retaining member is placed over the body, the retaining member and the lip secure the boot to the body.

According to a sixth broad aspect of the present invention, there is disclosed a fiber locking apparatus comprising: a ferrule having a compressible body and at least one passage through the body sized to accommodate a fiber; a structure having a wall surface; and a channel adapted for fixation to the wall surface and adapted to accept the ferrule in a friction fit; whereby, when the ferrule is inserted into the channel with a fiber extending through its at least one passage, the channel compresses the body, causing the diameter of the at least one passage to decrease uniformly along the length of the passage and uniformly apply pressure on the fiber, thereby securing it to the structure.

According to a seventh broad aspect of the present invention, there is disclosed a boot attachment apparatus comprising: a boot; a ferrule having a body and a lip formed around the body; a structure having a wall surface; and a channel adapted for fixation to the wall surface and adapted to accept the ferrule in a friction fit; whereby, when the boot is slid longitudinally over one end of the ferrule and inserted into the channel, the channel and the lip secure the boot to the ferrule and to the structure.

According to an eighth broad aspect of the present invention, there is disclosed a method of securing a fiber to a structure, comprising the steps of: forming a channel proximate to an opening in a wall surface of the structure; inserting the fiber into a passage in a compressible ferrule sized to accommodate the fiber and adapted to be accepted by the channel in a friction fit; placing the ferrule within the channel; whereby, the channel compresses the body, causing the diameter of the at least one passage to uniformly decrease and apply uniform pressure on the fiber, thereby securing it to the structure.

According to a ninth broad aspect of the present invention, there is disclosed a method of securing a boot to a fiber, comprising the steps of: inserting the fiber into a passage in a ferrule sized to accommodate the fiber, the ferrule having a lip formed around its body; placing the ferrule within the channel; sliding a boot longitudinally over one end of the ferrule to cover the lip; and inserting the ferrule and boot into a channel adapted to accept the ferrule in a friction fit; whereby the channel and the lip secure the boot to the ferrule.

### BRIEF DESCRIPTION OF THE DRAWINGS

The embodiments of the present invention will now be described by reference to the following figures, in which identical reference numerals in different figures indicate identical elements and in which:

FIG. 1 is an exploded isometric view of a removable fiber strain relief and locking apparatus in accordance with an embodiment of the present invention;

FIG. 2 is an isometric view of the ferrule of the embodiment of FIG. 1;

FIG. 3 is an isometric view of the ferrule and retaining member of the embodiment of FIG. 1;

FIG. 4 is an exploded isometric view of an apparatus in accordance with a second embodiment of the present invention;

FIG. 5 is an isometric view of the ferrule and the retaining member of the embodiment of FIG. 4;

FIG. 6 is a partially exploded isometric view of the apparatus of the embodiment of FIG. 1 when assembled but in the unlocked position;

FIG. 7 is a partially exploded isometric view of the apparatus of the embodiment of FIG. 1 when assembled but in the locked position;

FIG. 8 is a sectional view of the apparatus of the embodiment of FIG. 1 when assembled; and

FIG. 9 is an isometric view of a ferrule in accordance with a third embodiment of the present invention.

### DETAILED DESCRIPTION OF THE PREFERRED EMBODIMENTS

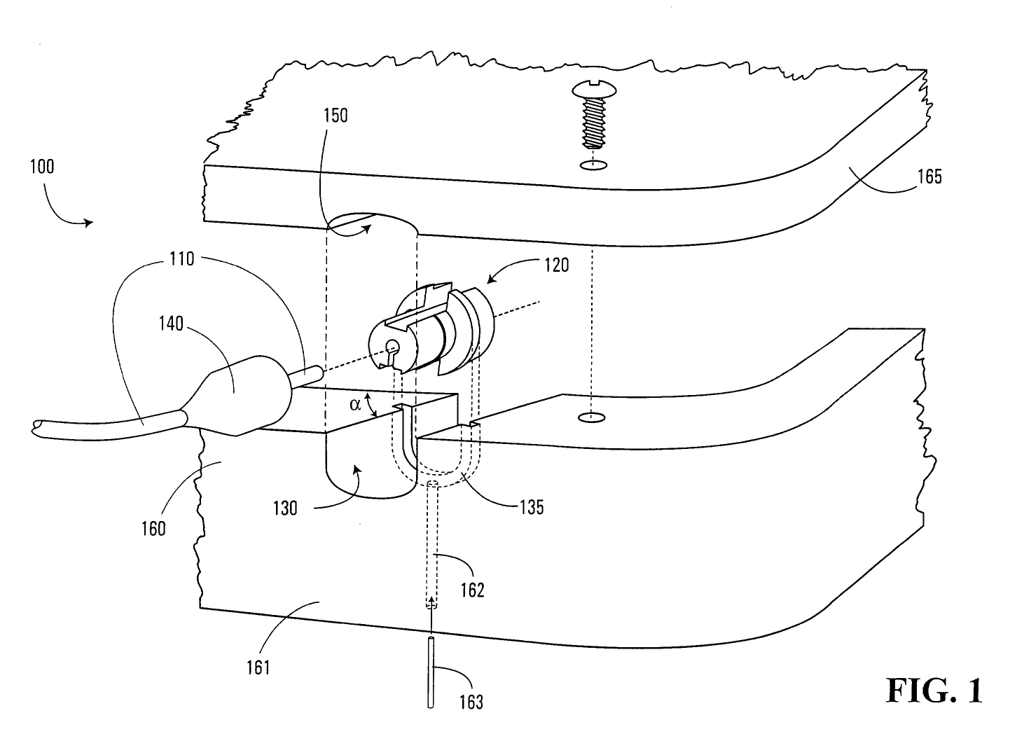

Referring now to FIG. 1, there is shown a structure 160, to which a optical fiber 110 is to be attached, by an apparatus, shown generally at 100.

In the embodiment of FIG. 1, the structure 160 is the bottom portion of an enclosure for an optical system, module or component (not shown). The enclosure may be completed by a fitted cover 165 which can be fixed to the structure 160, by means of fasteners in known fashion.

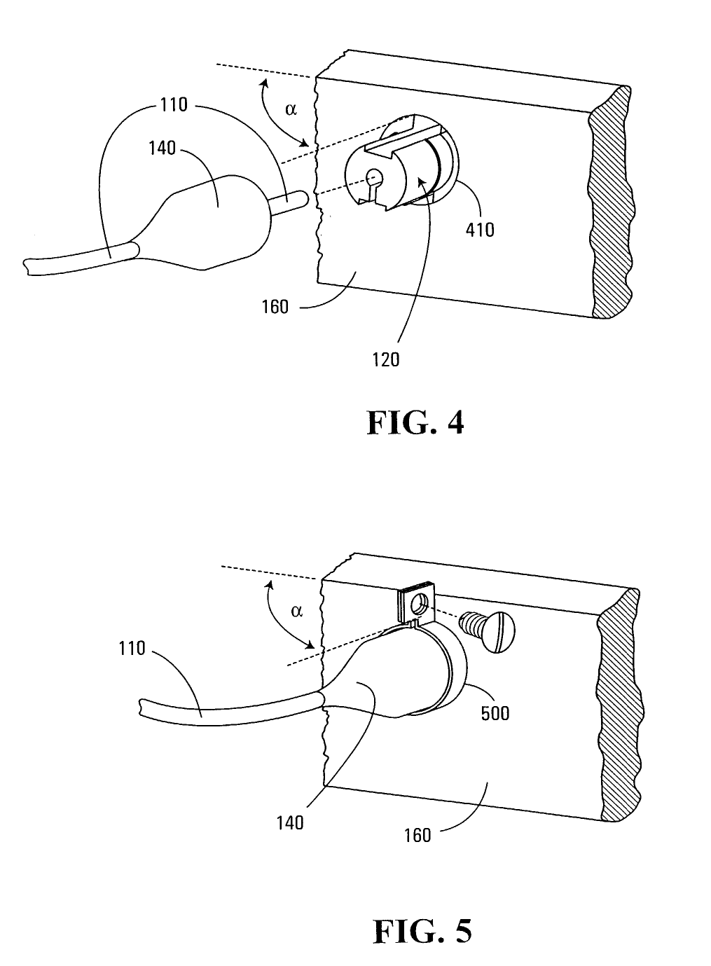

Alternatively, the structure 160 may comprise a faceplate through which the optical fiber 110 is to pass and to which it is to be attached as shown in FIG. 4.

The apparatus 100 comprises a ferrule 120, a channel 130, a strain relief boot 140 and a retaining member 150.

The optical fiber 110 typically comprises successive cylindrical layers commencing at the interior with a glass or plastic fiber and terminating at the exterior with an outer jacket, typically of a polymer material. Between the jacket and the central glass fiber may be disposed one or more layers of covering, cladding, and/or insulation. The intermediate layers of covering, cladding and/or insulation are selected for their protective and/or optical properties and may comprise any number of materials, including Kevlar™. The intermediate layers may be designed to compress slightly and absorb stresses that would otherwise be imposed upon the central fiber. The jacket is intended to contain the intermediate layers and to protect the central glass fiber from injury. The outer diameter of the optical fiber 110 in this embodiment is 900 μm. However, those skilled in this art will recognize that the optical fiber 110 may generally be of any diameter.

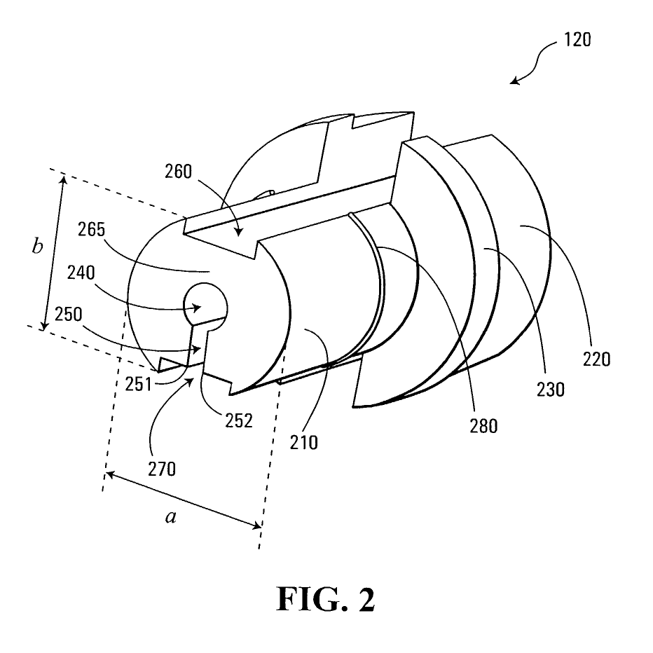

As best viewed in FIG. 2, the ferrule 120 is substantially cylindrical in shape. In the embodiment of FIG. 1, the ferrule 120 comprises first and second coaxial cylindrical portions 210, 220, having different diameters, disposed end to end. The second portion 220 is shown as having a larger cross-section than the first cylindrical portion 210. However, those skilled in this art will recognize that the ferrule 120 could equally comprise a single cylindrical portion.

The ferrule 120 is composed of a resilient material that has excellent flexural properties and is preferably composed of a non-flammable material, such as PEEK. It will be recognized that other suitable materials may include machined aluminum and other plastics.

In the present embodiment, for use with a single 900 μm (0.0354″) outer diameter jacketed optical fiber, a suitable diameter of the first cylindrical section 210 is 0.150″. A suitable diameter of the second cylindrical section 220 is 0.200″.

A central bore 240 or passage extends coaxially through the first and second cylindrical portions 210, 220. The bore 240 is of sufficient diameter to accept the optical fiber 110 without frictional contact. In the present embodiment, a bore diameter of 0.036″ is suitable.

A first rectangularly shaped notch 260 extends along the length of the ferrule 120 and radially inward from the surface of the ferrule 120. The depth of the first notch 260 varies along the length of the ferrule 120 such that the depth of the material 265 remaining between the first notch 260 and the bore 240 remains constant along the length of the ferrule 120. A suitable depth of the material 265 remaining between the first notch 260 and the bore 240, at its narrowest, is 0.020″. A suitable width of the first notch 260 may be 0.063″.

A slot 250 extends radially outward from the bore 240 along the length of the ferrule 120 to the surface of the ferrule 120 where it terminates in a second notch 270. The width of the slot 250 is sufficient so that when the extremities 251, 252 of the slot 250 are pinched together, the diameter of the bore 240 will be sufficiently reduced to firmly grip the optical fiber 110. In the present embodiment, a suitable width of the slot 250 is 0.024″. A suitable width of the second notch may also be 0.063″. When the extremities 251, 252 are pinched together, the bore 240 is reduced in diameter to 0.023″.

As a result of the removal of the material in the notches 260, 270, the width of the ferrule, measured across diameter b is slightly less than the width of the ferrule measured along diameter a. In the present embodiment, the difference in width, measured at the end of the second cylindrical portion 220, amounts to 0.020″.

The material 265 remaining between the bore 240 and the first notch 260 is sufficiently thin that the extremities 251, 252 of the slot 250 may be pinched together with a minimum of force. At the same time, the remaining material 265 is sufficiently thick so as to permit the ferrule 120 to return to its original shape once the applied force is removed.

A cylindrical key 230 extends transversely about the outer surface of the second cylindrical portion 220 at an intermediate point along its length, without overlapping either of the two notches 260, 270. Suitable dimensions for the key 230 may be a diameter of 0.229″ and a depth of 0.045″.

A cylindrical lip 280 extends transversely about the outer surface of the first cylindrical portion 210 at an intermediate point along its length, without overlapping either of the two notches 260, 270. The lip 280 is of such a diameter as to readily accept the larger end of the strain relief boot 140 discussed below. A suitable diameter is 0.166″.

Referring once again to FIG. 1, the channel 130 is a U-shaped channel that is integral to or is fixed to the structure 160 to which the fiber 110 is to be connected.

The width of the channel 130 is greater than the width of the second cylindrical portion 220 along direction b but less than the width of the second cylindrical portion 220 along direction a. The channel 130 is sufficiently deep to accept substantially all of the ferrule 120. In the present embodiment, a channel width of 0.202″ and a depth at its deepest of 0.301″ are suitable.

The channel 130 has a semicylindrical keyway 135 disposed transversely of its length and adapted to accept the key 230 of the ferrule 120.

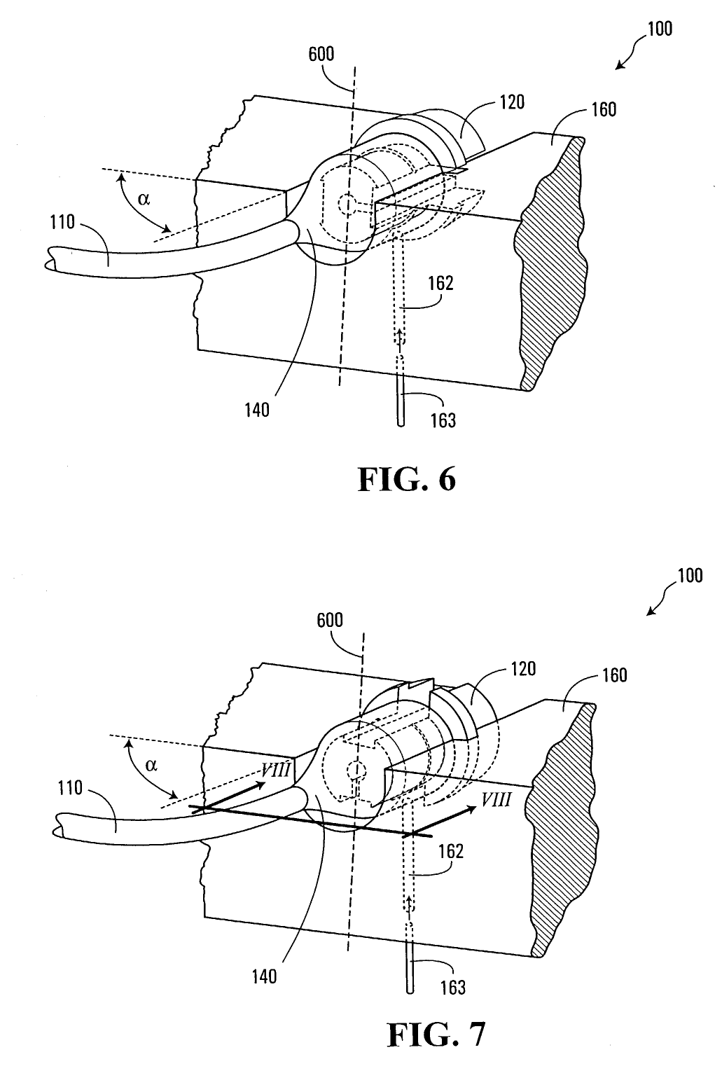

Accordingly, the channel 130 is adapted so that the ferrule 120 may be seated within it without the application of force when oriented so that the notches 260, 270 are roughly perpendicular to the axis 600 bisecting the channel 130, as shown in FIG. 6.

On the other hand, if the ferrule 120 is oriented so that the notches 260, 270 are bisected by the axis 600 bisecting the channel 130, as shown in greater detail in FIGS. 1 and 7, the ferrule 120 will engage the channel 130 in a tight friction fit.

The channel 130 may be oriented in any direction transverse to the surface of the structure 160, however preferably the channel 130 is positioned obliquely with respect to the surface of the structure 160 as shown in FIG. 1 as angle α. A suitable value for angle α is 30°.

Additionally, the channel 130 is positioned relative to the structure 160, such that the cylindrical lip 280 of the ferrule 120, when inserted into the channel 130, lies proximate to but does not extend beyond the surface 161 of the structure 160 from which the first cylindrical portion 210 protrudes. Where the structure 160 forms part of an enclosure, the surface 161 is the outer surface of the enclosure.

The strain relief boot 140 is roughly funnel-shaped. It has a bore of varying diameter passing entirely through its centre and is adapted to loosely fit over the first cylindrical portion 210 and the cylindrical lip 280. The boot 140 is composed of a resilient material, for example, a thermoplastic elastomer, and which also has a V-0 (UL94) flammability rating.

Suitable strain relief boots, such as model no. HW-20013-02 manufactured by Fotelco are also suitable for use in the present invention.

The retaining member 150 comprises a shaped member 155 which is integral to or fixed to the structure 160 to which the fiber 110 is to be connected.

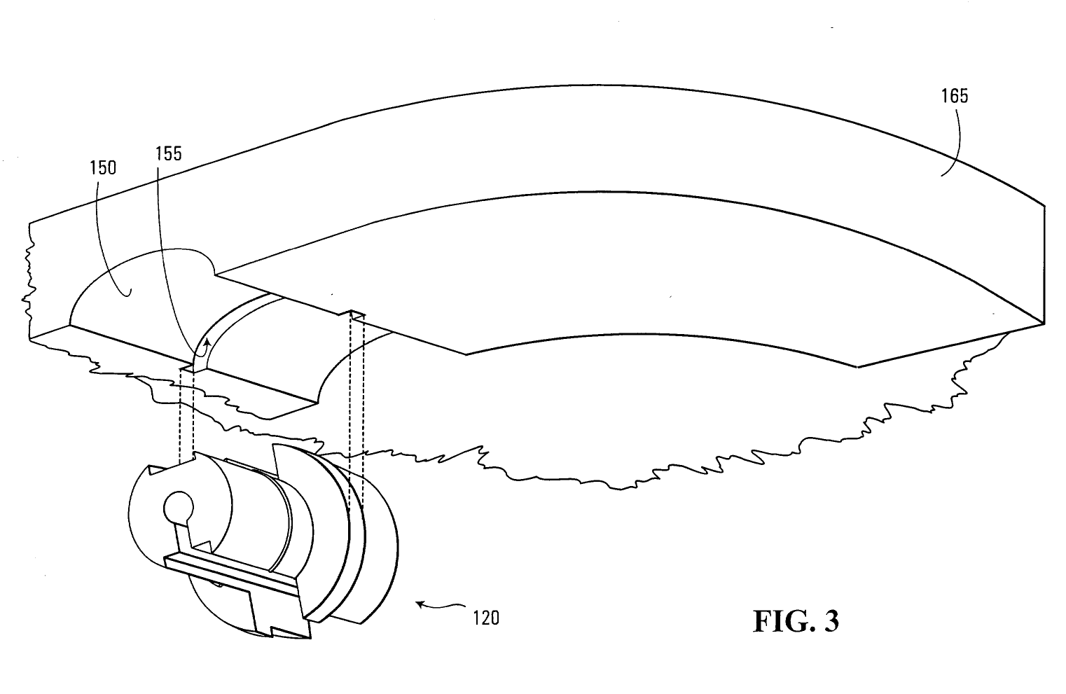

As shown in FIG. 1, the structure 160 is the bottom portion of an enclosure for an optical communications component or module and the channel 130 lies immediately below the edge of the structure 160 against which the cover 165 will be positioned and fixed. In this embodiment, the retaining member 150 may be integral to the enclosure cover 165, as also shown in FIG. 1 and shown in detail in FIG. 3.

The retaining device 150 is oriented in the same direction a as the channel 130. The profile of the retaining device 150 is adapted to mate with the channel 130 and key 230 on ferrule 120. The profile of the retaining device 150 includes a curved surface that is adapted to tightly mate with the compliant strain relief boot 140 that is inserted over the cylindrical lip 280 of the ferrule 120.

In operation, the optical fiber 110 is inserted into the bore 240 of the ferrule 120. The ferrule 120 is oriented with respect to the fiber 110 such that the first cylindrical portion 210 of the ferrule 120 is facing that portion of the fiber 110 that will protrude beyond the surface 161 of the structure 160 when the apparatus is attached to the structure.

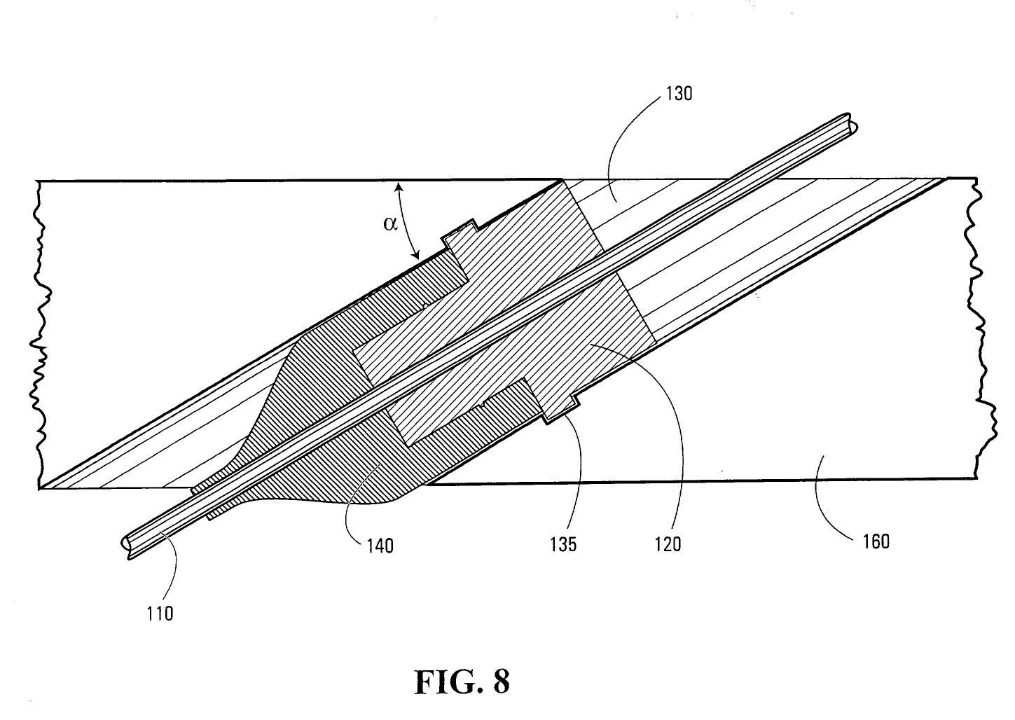

The strain relief boot 140 is thereafter fitted over the cylindrical lip 280 and the first cylindrical portion 210 of the ferrule 120. The strain relief boot 140 may only protrude over the ferrule 120 to a limited extent, stopped by the wall of the key 230, as shown in cross-section in FIG. 8.

The ferrule 120 and the strain relief boot 140 are then inserted into the channel 130 so that direction a is parallel to the axis 600 bisecting the channel 130, and with the key 230 lying within the keyway 135 of the channel 130.

In this position, shown in FIG. 6, the ferrule 120 lies loosely within the channel 130, so that the channel 130 applies no compressive force on the ferrule 120. The ferrule 120 is prevented from movement longitudinally with respect to the channel 130 because of the interlocking of the ferrule's key 230 and the channel's keyway 135. Nevertheless, the fiber 110 remains relatively free within the ferrule 120 to move longitudinally in either direction. Thus, the position of the apparatus as shown in FIG. 6 is considered to be unlocked.

While in this position, the fiber 110 can be longitudinally adjusted with the apparatus 100 in place to ensure that there is a sufficient length of fiber 110 on either side of the structure 160 to meet the requirements of the application for which the fiber 110 is used.

The loose fit of the ferrule 120 in the channel 130 while unlocked permits adjustments to be conveniently made without having to hold the fiber 110 in position.

Once such longitudinal adjustments to the position of the fiber 110 have been made, the ferrule 120 and the strain relief boot 140, if in place, are removed from the channel 130. The ferrule 120 is rotated 90° so that the slot 250 is positioned parallel to the axis of the channel 130 and facing the closed end of the channel 130. While the ferrule 120 is being rotated, the fiber 110 typically is not rotated, so as to avoid a torsional stress being imposed on the fiber 110.

The ferrule 120, while in this rotated or locked position, together with the fiber 110 and the strain relief boot 140, are reinserted into the channel 130, as shown in FIG. 7. In this orientation, the width of the ferrule 120 is slightly greater than the width of the channel 130. Accordingly, a slight force is required to push the ferrule 120 completely into the channel 130.

The amount of force required to insert the ferrule 120 into the channel 130 in the locked position is minimized by a suitable choice of material for the ferrule 120 and by the presence of the notches 260, 270. The notch 260 serves to remove material from the ferrule 120 on the side of the bore 240 opposite the slot 250, so that less force is required to insert the ferrule 120 into the channel 130.

The curved profile of the ferrule 120 and the second notch 270 also serve to minimize the required insertion force.

This insertion force imposes a slight compressive force on the ferrule 120 where it comes into contact with the channel, forcing the ends 251, 252 of the slot 250 to approach each other and the slot 250 to narrow in width substantially uniformly along its length. Accordingly, the ferrule 120 is placed in a friction fit with the channel 130 and cannot be easily removed.

Indeed, in order to permit the ferrule 120 to be more easily removed from the channel 130 when in the locked position, a small removal bore 162 may extend from the surface 161 of the structure 160 to the bottom of the channel 130. The removal bore 162 may be conveniently situated in the bottom of the keyway 135. When the ferrule 120 must be removed, a tool 163 may be inserted into the removal bore 162 to push the ferrule 120 out of the channel 130.

Furthermore, the compression of the slot 250 causes the diameter of the bore 240 to reduce slightly and to grip the fiber 110 with a uniform pressure longitudinally along the length of the ferrule 120 and axially about the fiber 110 in a friction fit. The friction fit prevents the fiber 110 from thereafter being moved longitudinally with respect to the ferrule 120, and by extension, the structure 160.

The uniformity of the pressure applied by the ferrule 120 on the fiber 110 minimizes the possibility of breakage of the fiber 110. It also reduces the likelihood degradation in optical performance of the fiber 110.

The removability of the ferrule 120 means that, if the optical performance of the fiber 110 is monitored during the installation process and if any degradation is observed, the ferrule 120 can be removed, as discussed above, the fiber 110 adjusted and the ferrule 120 reinserted.

The interaction of the channel 130 with the ferrule 120, whether in the locked or unlocked position, also serves to pinch a portion of the strain relief boot 140 between the cylindrical lip 280 of the ferrule 120 and the channel 130. Thus, the strain relief boot 140 is temporarily fixed in place to varying degrees. However, the strain relief boot 140 is easily removed from between the cylindrical lip 280 of the ferrule 120 and the channel 130, whether or not the ferrule 120 is lifted from the channel 130. Thus the adjustment of the strain relief boot 140 may be performed independently from adjustment of the fiber 110.

When the fiber 110 is satisfactorily attached to the structure 160 by means of the interaction of the ferrule 120 in the locked position and the channel 130, the retaining member 150 is applied to the channel 130. Where, as shown in FIG. 3, the retaining member 150 is integral with the cover 165 of the structure 160, this is accomplished merely by fastening the cover 165 to the enclosure by known means.

It is not until the retaining member 150 is attached to the channel 130, that the strain relief boot 140 is firmly attached to the ferrule 120, and thus, the structure 160. When the retaining member 150 is attached, it pinches the rest of the strain relief boot 140 that is in contact with the cylindrical lip 280 of the ferrule and applies uniform pressure around the circumference of the strain relief boot 140 where it comes into contact with the cylindrical lip 280 of the ferrule. As shown in FIG. 8, the tight engagement between the retaining member 150, the strain relief boot 140, the cylindrical lip 280 and the channel 130 fixes the strain relief boot 140 in relation to the ferrule 120, and by extension, to the fiber 110 and to the structure 160.

In conjunction with the oblique orientation of the channel 130 relative to the surface 161 of the structure, the strain relief boot 140 thereafter acts to protect the fiber 110 from severe bending.

As shown in FIG. 1, the channel 130 lies immediately below the edge of the structure 160 against which the cover 165 will be positioned. Alternatively, as shown in FIG. 4, the channel 410 may constitute an opening in the structure 160 that is sufficiently large to accept the cross-section of the first cylindrical portion 210 but smaller than the cross-section of the key 230. The channel 410 may be integral with or attached to the structure 160 by machine screws or other known fastening means.

The channel 410 will not have a keyway 135. Rather, the channel 410 and the key 230 will cooperate to prevent the ferrule 120 from moving forward through the opening 400 in the structure 160. The interaction of the channel 410 and the retaining member 500, discussed below, will prevent the ferrule 120 from moving backward away from the structure 160.

In this alternative embodiment, the retaining member 500 will be a discrete component for attachment to the structure 160 immediately above the channel 410, as shown in FIG. 5. The retaining member 500 may also be used in conjunction with the channel 130 of the first embodiment as an alternative to integrally molding the retaining member 150 into the cover 165, although of slightly different configuration.

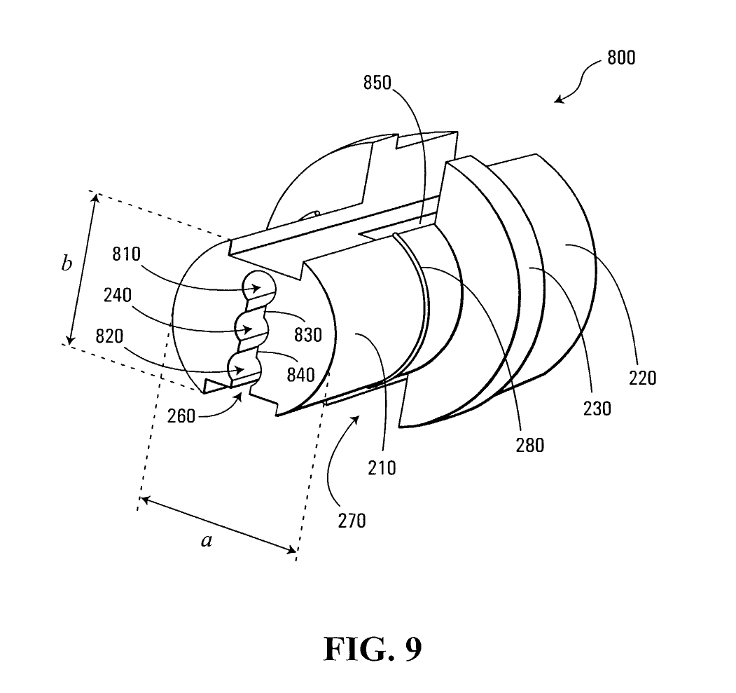

Those having ordinary skill in this art will also readily appreciate that the apparatus 100 can accept a plurality (two or more) of fibers 110. As shown in FIG. 9, the ferrule 800 may have a plurality of bores or passages 240, 810, 820. These bores are disposed longitudinally through the ferrule 800, between the first and second notches 260, 270. The bores 240, 810, 820 are separated by slots 830, 840. The slots extend along the diameter extending in direction b of the ferrule 800.

Additionally, a partial slit 850 extends between the bore 810 approximate to the second notch 270, but only along a portion of the length of the ferrule 800, starting from the extremity of the second cylindrical portion 220. The partial slit 850, the slots between the bores 240, 810, 820 are chosen to ensure relative uniformity of gripping pressure on the fibers 110 passing through the bores 240, 810, 820.

The use of a single ferrule 800 to attach a plurality of fibers 110 is advantageous as an objective of many optical components is to minimize the footprint of the device. Using a multi-fiber ferrule 800 permits the structure 160 to be smaller, because fewer channels 130 must be provided in the structure 160. Additionally, the device can be manufactured at a lower cost because the cost of preparing the channels 130 and the retaining devices will be correspondingly reduced, without increasing the cost of the ferrule 800 appreciably or at all. As well, fewer strain relief boots 140 will be required. A slight saving on installation of the fibers 110 may also be realized in such an application.

The number of bores 240, 810, 820 that may be added to a ferrule 800 will be limited by a number of factors. First, the overall dimensions of the ferrule 800, and the corresponding dimensions of the channel 130 and the retaining member 150 will only permit a limited number of bores 240, 810, 820. Second, the ability of the ferrule 800 to apply sufficient gripping force on the fibers 110 and the strain relief boot 140, will be affected by the number of bores 240, 810, 820. Third, the smaller footprint may restrict an installer's ability to position fibers 110 in a confined space within the structure without risk of fiber breakage or degradation in optical performance.

Experimentation has demonstrated that a ferrule 800 with two or three bores 240, 810, 820 (i.e. two or three fibers 110 per ferrule 800) can be easily implemented. Nevertheless, the upper limit on the number of bores 240, 810, 820 has not been determined to date.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

We claim:

1. A ferrule comprising:
a compressible body; and
at least one passage through the body sized to accommodate a fiber;
whereby when a fiber is placed inside the at least one passage and pressure is exerted on the body, the body is compressed, causing the diameter of the at least one passage to decrease uniformly along its length and consequently friction to be uniformly applied to the fiber.

2. The ferrule of claim 1 wherein a slot extends between the outer surface of the body along its length and a passage proximate thereto, whereby, when the body is compressed, the slot distorts and causes the diameter of the passage to decrease.

3. The ferrule of claim 1 wherein a slot extends between adjacent passages along their length, whereby, when the body is compressed, the slot distorts and causes the diameter of the passages connected thereto to decrease uniformly along the length of the passage.

4. The ferrule of claim 2 wherein the body comprises at least one notch along the outer surface of the body along a diameter defined by the slot, for reducing the width of the body along that diameter.

5. The ferrule of claim 4, wherein when the body is so oriented that the pressure exerted is in the direction of reduced width, the amount of compressive force applied to the body and the friction applied to the fiber are reduced.

6. The ferrule of claim 5, wherein when the body is so oriented that the pressure exerted is in the direction of reduced width, the fiber remains free to move longitudinally relative to the ferrule.

7. The ferrule of claim 5, wherein when the body is so oriented that the pressure exerted is in the direction of reduced width, the fiber remains free to rotate relative to the fiber.

8. The ferrule of claim 1, wherein the apparatus is adapted to cooperate with a channel to apply pressure substantially uniformly along the length of the body when the body is inserted into the channel.

9. The ferrule of claim 1, wherein the apparatus is adapted to cooperate with a channel to restrict the body from motion relative to the channel.

10. The ferrule of claim 9, wherein the body comprises a key integrally formed about its outer surface.

11. The ferrule of claim 10 wherein the body comprises first and second ends, and where the key lies between the first and second ends.

12. The ferrule of claim 11 wherein the first end has a diameter less than that of the second end.

13. The ferrule of claim 10 wherein the key is adapted to mate with a keyway in the channel.

14. The ferrule of claim 10 wherein the key is larger than an opening in a wall surface of a structure proximate to which the channel is fixed, whereby the key is prevented from passing through the opening.

15. The ferrule of claim 9 comprising a lip integrally formed around the body whereby, when a boot is slid longitudinally over one end of the body to cover the lip, the lip and the channel exert radial pressure on the boot in a direction away from the body.

16. The ferrule of claim 8 wherein the body fits within the space created by the channel and a retaining member in a mating fit with the channel.

17. A ferrule comprising:
a body; and
a lip integrally formed around the body and adapted to cooperate with a channel in a friction fit;
whereby when a boot is slid longitudinally over one end of the apparatus to cover the lip and the apparatus is inserted into a channel, the channel and the lip secure the boot to the apparatus.

18. The ferrule of claim 12 wherein the body comprises an integral stop surface on its outer surface, which limits the boot from motion along the body toward the other end.

19. The ferrule of claim 18, wherein the stop surface is adapted to cooperate with the channel to restrict the body from motion relative to the channel.

20. The ferrule of claim 19, wherein the stop surface comprises a key formed around the body.

21. The ferrule of claim 17 wherein the body is compressible and has at least one passage therethrough sized to accommodate a fiber.

22. The ferrule of claim 21 whereby when a fiber is placed inside at least one of the passages and pressure is exerted on the body, the body is compressed, causing the diameter of the passage to decrease uniformly along the length of the body and friction to be uniformly applied to the fiber.

23. The ferrule of claim 17 wherein the body and boot fit within the space created by the channel and a retaining member in a mating fit with the channel.

24. The ferrule of claim 23, whereby the retaining member pinches the boot between it and the lip, such that pressure is uniformly applied by the lip on the boot.

25. A channel sized to accommodate a compressible body in a friction fit,
whereby when a compressible body having at least one passage sized to accommodate a fiber and containing a fiber is inserted into the channel, the channel compresses the body uniformly along the length of the body and causes friction to be uniformly applied by the body to the fiber.

26. The channel of claim 25 which is U-shaped.

27. The channel of claim 25, having a width which is fixed and less than the width of the body in one direction normal to the at least one passage but not in a second direction normal to the at least one passage.

28. The channel of claim 27, whereby it only compresses the body if the body is inserted into the channel in the first direction.

29. The channel of claim 26, adapted to cooperate with the body to restrict the body from motion relative to the channel.

30. The channel of claim 29, comprising a keyway adapted to cooperate with a key formed around the body.

31. The channel of claim 26, adapted to exert radial pressure on a boot slid longitudinally over one end of the body when the body is inserted into the channel, securing the boot to the body.

32. The channel of claim 26, wherein it passes through a wall surface of a structure, whereby the compressible body and fiber may be fixed to the structure.

33. The channel of claim 32, wherein it is positioned at an oblique angle relative to the wall surface.

34. The channel of claim 26, adapted to be fixed adjacent to an opening in a wall surface of a structure, whereby the compressible body and fiber may pass partially through the opening and be fixed to the structure.

35. The channel of claim 34, wherein it is positioned at an oblique angle relative to the wall surface.

36. The channel of claim 26, comprising a bore adapted to accept a tool for pushing the body away from the channel.

37. The channel of claim 26, adapted to mate with a retaining member and enclose the body.

38. A channel, adapted to accommodate a body having a lip therearound in a friction fit,
whereby when a boot is slid longitudinally over one end of the body to cover the lip and inserted into the channel, the channel and the lip secure the boot to the body.

39. The channel of claim 38, adapted to cooperate with the body to restrict the body from motion relative to the channel.

40. The channel of claim 39, comprising a keyway adapted to accommodate a key formed around the body.

41. The channel of claim 38, wherein it passes through a wall surface of a structure so that the boot is secured by the channel and the lip to the structure.

42. The channel of claim 41, wherein it is positioned at an oblique angle relative to the wall surface.

43. The channel of claim 38, wherein it is fixed to a structure proximate to an opening in a wall surface of a structure, whereby the boot is secured by the channel and the lip to the structure.

44. The channel of claim 43, wherein it is positioned at an oblique angle relative to the wall surface.

45. The channel of claim 43, wherein the opening is sized smaller than a key formed around the body, so that the body cannot pass through the opening.

46. The channel of claim 38, adapted to engage a retaining member in a mating fit and enclose the body and boot, whereby the retaining member pinches the boot between it and the body, such that pressure is uniformly applied to the boot.

47. The channel of claim 46, wherein it is capable of being fastened to the retaining member.

48. A retaining member adapted to accommodate a body having a lip therearound,
whereby when a boot is slid longitudinally over one end of the body to cover the lip and the retaining member is placed over the body, the retaining member and the lip secure the boot to the body.

49. The retaining member of claim 48, adapted to engage a channel in a mating fit and enclose the body and boot, whereby the channel pinches the boot between it and the body, such that pressure is uniformly applied to the boot.

50. The retaining member of claim 48, wherein it is integral to a cover of a structure to which the body is to be secured.

51. The retaining member of claim 48, wherein it is capable of being fastened to the channel.

52. A fiber locking apparatus comprising:
a ferrule having a compressible body and at least one passage through the body sized to accommodate a fiber;
a structure having a wall surface; and
a channel adapted for fixation to the wall surface and adapted to accept the ferrule in a friction fit;
whereby, when the ferrule is inserted into the channel with a fiber extending through its at least one passage, the channel compresses the body, causing the diameter of the at least one passage to decrease uniformly along the length of the passage and uniformly apply pressure on the fiber, thereby securing it to the structure.

53. The apparatus of claim 52 wherein the ferrule comprises a key integrally formed around the body and adapted to cooperate with the structure to restrict the ferrule from motion relative to the structure.

54. The apparatus of claim 53 wherein the structure comprises a recessed keyway in the channel that accommodates the key to restrict the ferrule from motion relative to the structure.

55. The apparatus of claim 53 wherein the structure comprises an aperture therein sized smaller than the key, whereby the key is prevented from passing through the opening.

56. The apparatus of claim 52 wherein the ferrule comprises a lip integrally formed around the body, whereby, when a boot is slid longitudinally over one end of the body to cover the lip, the channel and the lip secure the boot to the ferrule.

57. The apparatus of claim 56 wherein the body comprises an integral stop surface on its outer surface, which limits the boot from motion along the body toward the other end.

58. A boot attachment apparatus comprising:
a boot;
a ferrule having a body and a lip formed around the body;
a structure having a wall surface; and
a channel adapted for fixation to the wall surface and adapted to accept the ferrule in a friction fit;
whereby, when the boot is slid longitudinally over one end of the ferrule and inserted into the channel, the channel and the lip secure the boot to the ferrule and to the structure.

59. The apparatus of claim 58, wherein the body comprises an integral stop surface on its outer surface, which limits the boot from motion along the body toward the other end.

60. The apparatus of claim 52, wherein the body is compressible and has at least one passage through it sized to accommodate a fiber;
whereby, when the ferrule is inserted into the channel with a fiber extending through at least one passage, the channel compresses the body, causing the diameter of the passage to decrease uniformly along the length of the passage and apply uniform pressure on the fiber, securing it to the structure.

61. The apparatus of claim 58 wherein the ferrule comprises a key integrally formed around the body and adapted to cooperate with the structure to restrict the ferrule from motion relative to the structure.

62. The apparatus of claim 61 wherein the structure comprises a recessed keyway in the channel that accommodates the key to restrict the ferrule from motion relative to the structure.

63. The apparatus of claim 61 wherein the structure comprises an aperture therein sized smaller than the key, whereby the key is prevented from passing through the opening.

64. The apparatus of claim 58, further comprising a retaining member adapted to engage the channel in a mating fit and enclose the body and boot, whereby the channel pinches the boot between it and the body, such that pressure is uniformly applied to the boot.

65. The apparatus of claim 58 wherein the boot provides both lateral and longitudinal strain relief for the optical fiber.

66. A method of securing a fiber to a structure, comprising the steps of:
forming a channel proximate to an opening in a wall surface of the structure;
inserting the fiber into a passage in a compressible ferrule sized to accommodate the fiber and adapted to be accepted by the channel in a friction fit;
placing the ferrule within the channel;
whereby, the channel compresses the body, causing the diameter of the at least one passage to uniformly decrease and apply uniform pressure on the fiber, thereby securing it to the structure.

67. A method of securing a boot to a fiber, comprising the steps of:
inserting the fiber into a passage in a ferrule sized to accommodate the fiber, the ferrule having a lip formed around its body;
placing the ferrule within the channel;
sliding a boot longitudinally over one end of the ferrule to cover the lip; and
inserting the ferrule and boot into a channel adapted to accept the ferrule in a friction fit;
whereby the channel and the lip secure the boot to the ferrule.
